(19) United States
(12) Patent Application Publication
(10) Pub. No.: US 2014/0272266 A1
(43) Pub. Date: Sep. 18, 2014

(54) Multi layered covering material and process for making multi layered covering material for elements making furniture more comfortable comprising upholstery, cushions, blankets, and similar elements

(71) Applicant: BOXMARK LEATHER d.o.o, Kidricevo (SI)

(72) Inventor: Nino Svilar, Maribor (SI)

(73) Assignee: BOXMARK LEATHER d.o.o, Kidricevo (SI)

(21) Appl. No.: 14/191,590

(22) Filed: Feb. 27, 2014

(30) Foreign Application Priority Data
Mar. 12, 2013 (EP) 13001249.5

(51) Int. Cl. A47C 7/02; A47G 9/02; A47C 7/24; B68G 7/052; A47C 31/11

(52) U.S. Cl. CPC A47C 7/021; B68G 7/052; A47C 31/11; A47C 7/24; A47G 9/0223
USPC 428/101; 29/91.1; 112/475.08; 139/408; 112/402

(57) ABSTRACT

Multi layered covering material for upholstery solves above referenced technical problem by combining two materials: one which is friendly to skin or to touch, and prone to stretching or other types of shape change under environmental influence, and one which is not—so friendly material can perform function of being friendly, and the other material provides support so friendly material would not change its shape even if, for example, wet. This patent application also covers process for making multi covering material for elements making furniture more comfortable comprising upholstery, cushions, blankets, and similar elements, said multi layered covering material comprising steps of aligning outer layer (1) comprised of at least one user friendly material prone to change shape under environmental influence, preferably moisture over inner layer (2) comprised of material essentially resistant to shape change under environmental influence, and connecting said layers together.

### FOREIGN PRIORITY CLAIM

The present application claims priority under the Paris Convention from EPO Patent Application No. EP13001249.5, filed Mar. 12, 2013, and incorporated herein by reference.

### FIELD OF THE INVENTION

The present invention relates to upholstery cushions. In particular, the present invention is directed toward a multi-layered covering material and process for making same, for elements making furniture more comfortable.

### BACKGROUND OF THE INVENTION

The technical problem to be solved by present invention is prevention of shape change of covering, preferably leather or textile, as a result of environmental factors such as moisture, heat, combination thereof or other factors unfriendly to covering materials.

Current upholstery used for top of the line application is usually made of skin friendly fabrics or other covering materials. Unfortunately, these covering materials are usually cotton or leather. One of properties of these natural materials is also sensitivity to environmental factors such as moisture, and heat. For example, if there is a cushion for a seat made of filling covered in leather, this leather may, under influence of environmental factor, change its shape. If there is rain falling on such a cushion, wet leather will stretch. If there is sun following rain (or other moisture application) such leather will shrink, and also become brittle. Such environmental factors are especially abundant in case of upholstery used is applications such as marine upholstery or garden furniture upholstery.

If the covering material is perforated this does help to let the water through the covering, however, the material will still get wet, and as a result, experience change of shape.

There is no simple solution available to these problems, and this patent is addressing them.

### SUMMARY OF THE INVENTION

Multi layered covering material for elements making furniture more comfortable comprising upholstery, cushions, blankets, and similar elements solves above referenced technical problem by combining two materials: one which is friendly to skin or to touch, and prone to stretching or other types of shape change under environmental influence, and one which is not—so friendly material can perform function of being friendly, and the other material provides support so friendly material would not change its shape even if, for example, wet.

It should be noted that in this application word upholstery in addition to classic upholstery which is immovably attached to the furniture also covers and means all kind of cushions which can easily be removed from the supporting elements such as benches, chairs, deckchairs and similar. The word “upholstery” as used in the present application is simply chosen to cover all elements which are used to make furniture more appealing for seating, and more comfortable regardless whether they are permanently, temporary, or not at all attached to the furniture. This word is used both in description, and in claims, and means the same.

### BRIEF DESCRIPTION OF THE DRAWINGS

FIG. 1 is a cross section of upholstery showing outer layer (1), inner layer (2), stitch (3), padding (4), with padding and stitch in a preferred embodiment of the present invention.

FIG. 2 is a perspective view of upholstery, illustrating the type of stitching, including essentially rectangular (8) shape of closed stitching as well as the outer layer (1).

FIG. 3 is another perspective view of an upholstery of essentially circular (9) shape, illustrating closed stitching as well as the outer layer (1).

### DETAILED DESCRIPTION OF THE INVENTION

Such multi layered covering material is presented in FIG. 1 which is a cross section of upholstery showing outer layer (1), inner layer (2), stitch (3), padding (4), with padding and stitch in a preferred embodiment of the present invention.

The type of stitching is shown in FIG. 2 showing essentially rectangular (8) shape of closed stitching as well as the outer layer (1) and in FIG. 3 showing essentially circular (9) shape of closed stitching as well as the outer layer (1).

This patent application also covers process for making multi covering material for elements making furniture more comfortable comprising upholstery, cushions, blankets, and similar elements, said multi layered covering material comprising steps of aligning outer layer (1) comprised of at least one user friendly material prone to change shape under environmental influence, preferably moisture over inner layer (2) comprised of material essentially resistant to shape change under environmental influence, and connecting said layers together.

Covering material as described herein is comprised of an outer layer (1), and of an inner layer (2). The outer layer (1) is comprised of at least one skin friendly material prone to change shape under environmental influences such as rain, moisture, water from waves or other exposure to water or moisture, and further influences of sun or other heat. Combination of these harmful exposures would change leather or cotton, stretch it, shrink it, make it dry, even brittle. This outer layer (1) is connected to the inner layer (2) which is comprised of material essentially resistant to shape change under environmental influence such as for example a mesh made of glass fibers, or mesh made of polyester, or nylon, or other types of man made materials. These can include glass fiber, rock fiber, glass wool, rock wool, polyethylene, PVDC, polyester, naylon, rayon, thread of metal, preferably steel, and also combinations of any of these materials with another of these materials. Also other types of materials can be used provided that they do not stretch too much under influence of water, or heat, or other environmental factors (UV light etc.).

For both layers to perform they need to be connected one to another in such a way that the inner layer (2) acts as load bearing material, and outer layer (1) acts as covering material friendly to the user. This can be achieved by any means of connecting one layer to another, preferably by gluing or stitching.

In particular embodiment, in order to accommodate slight changes in the outer layer (1) both materials should be allowed to permit relative movements one to another except at connecting point.

This connecting point would be, ideally, in form of connecting elements. Most conveniently, the stitching should be used but also gluing is possible if the glue is not covering the whole area of both materials but is only applied in stripes so both materials are glued together in some places, and not glued in others and in latter areas the lateral movement is possible.

The best results are achieved when this stitch (3) is forming essentially closed thread, i.e. thread which runs around the area used for load (e.g. sitting) providing fixed point of attachment between the outer layer (1) and the inner layer (2). Such thread can be in essentially rectangular (8) form or in essentially circular (9) form, or in essentially any form provided that it is closed, and that enables the inner layer (2) to perform its load bearing function.

Of course, there can be many threads connecting both layers, but at the minimum there should be stitching necessary for the outer layer (1) to essentially retain its form even under severe environmental conditions, while not sliding off the outer layer (2) so outer layer (2) can perform its load bearing function.

The outer layer (1) can be made of single material, such as leather, or plurality of material, such as leather, cotton or other types of material intertwined or connected together. The outer layer (1) should comprise user friendly material, i.e. material which is basically friendly to user's skin or touch, or is visually pleasing. Leather, especially fine grain leather, is example of such material, another one is cotton, but really any user friendly material can be used—this material should be pleasant to touch, to feel, to hold next to skin, it can also be anti-allergenic, and contrary to most upholstery solution it no longer has to be able to carry load as all load-bearing is taken over by the inner layer (2). The outer layer (1) can be any material friendly, in a way of example it can be selected from at least one of the following materials: leather, preferably fine grain leather, cotton, hemp, linen. The material of the outer layer (1) can be solid, or perforated, or in form of a mesh, or woven. The material of the outer layer (1) can therefore be at least solid material, perforated material, mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics, or combination thereof.

The inner layer (2) functions as load bearing layer. It is possible that the outer layer (1) bears part of the load, however, purpose of the inner layer (2) is to take over stress which would otherwise stretch or deform (change shape) of the outer layer (1). In order to perform its function the inner layer (2) should be constructed to bear loads in at least two degrees of freedom. Meshes, or plain weaves do have such property, but also other types of weaving can be used. The type of the inner layer (2) can be any type, and in a way of example it can be selected from at least one of the following: mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics. Such type also permit water to flow unimpeded through the material once it has passed the outer layer (1). The underlying idea of the inner layer (2) is to perform load carrying function and at the same time not retain moisture any longer than necessary.

The material of the outer layer (2) should be essentially resistant to environmental influences which can influence material of the inner layer (1) to change shape: moisture, heat, and similar. Examples of such material include glass fiber, rock fiber, glass wool, rock wool, polyethylene, PVDC, polyester, naylon, rayon, thread of metal, preferably steel.

Upholstery usually assumes that the covering material is attached to some kind of padding. The padding should be of kind to permeate the water and not to retain said water otherwise the moisture would have passed the outer layer (1) with its sensitive material only to be subject to diffusion from wet padding back into the outer layer (1). In preferred embodiment the padding (4) would be preferably of highly water-permeable, non-retentive, non-moisture storing foam.

In preferred embodiment fine grain colored leather is stitched to fine mesh made of glass fibers with closed stitch, and this material is attached by gluing and stitching to the padding.

Use of such upholstery include marine upholstery, and outdoor furniture upholstery avoiding the need to constantly remove the upholstery (in form of cushions, pillows, and similar) from the supporting furniture, and is clearly improvement over current state of the art requiring removal of sensitive cushioning lest it is subject to rot, mold, shape change, and other unpleasant reactions to environmental influences.

While the preferred embodiment and various alternative embodiments of the invention have been disclosed and described in detail herein, it may be apparent to those skilled in the art that various changes in form and detail may be made therein without departing from the spirit and scope thereof.

I claim:

1. Multi layered covering material for elements making furniture more comfortable comprising upholstery, cushions, blankets, and similar elements, said multi layered covering material comprising outer layer (1), and inner layer (2), said outer layer (1) comprised of at least one user friendly material prone to change shape under environmental influence, preferably moisture, and said inner layer (2) comprised of material essentially resistant to shape change under environmental influence, both layers connected one to another, preferably by gluing or by stitching, said inner layer (2) taking over essentially load carrying function of said multi layered covering material, wherein both layers are connected one to another in such a way as to permit relative movements one to another except at connecting point, said connecting point comprising only part of surfaces of said inner (2), and said outer (1) layers.

2. Multi layered covering material according to claim 1 wherein both layers are connected one to another with a stitch (3).

3. Multi layered covering material according to claim 1 wherein both layers are connected one to another at connecting point with at least a glue stripe, said glue stripe or plurality thereof only covering part of surfaces of said inner (2), and outer (1) layers so both materials are glued together in some places, and not glued in others.

4. Multi layered covering material according to claim 2, wherein said stitch (3) is in form of essentially geometrically closed stitch (3), preferably in form of essentially rectangle (8) or essentially circle (9).

5. Multi layered covering material according to claim 3, wherein said stitch (3) is in form of essentially geometrically closed stitch (3), preferably in form of essentially rectangle (8) or essentially circle (9).

6. Multi layered covering material according to claim 1, wherein material for said outer layer (1) is selected from at least one of the following materials: leather, preferably fine grain leather, cotton, hemp, linen.

7. Multi layered covering material according to claim 2, wherein material for said outer layer (1) is selected from at least one of the following materials: leather, preferably fine grain leather, cotton, hemp, linen.

8. Multi layered covering material according to claim 3, wherein material for said outer layer (1) is selected from at least one of the following materials: leather, preferably fine grain leather, cotton, hemp, linen.

9. Multi layered covering material according to claim 1, wherein said outer layer (1) is selected from at least one of the following: solid material, perforated material, mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics.

10. Multi layered covering material according to claim 2, wherein said outer layer (1) is selected from at least one of the following: solid material, perforated material, mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics.

11. Multi layered covering material according to claim 3, wherein said outer layer (1) is selected from at least one of the following: solid material, perforated material, mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics.

12. Multi layered covering material according to claim 1, wherein said inner layer (2) is selected from at least one of the following: mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics.

13. Multi layered covering material according to claim 2, wherein said inner layer (2) is selected from at least one of the following: mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics.

14. Multi layered covering material according to claim 3, wherein said inner layer (2) is selected from at least one of the following: mesh, plain weaved fabrics, hopsacks weaved fabric, poplin weaved fabrics, taffeta weaved fabrics, poult weaved fabrics, grossgrain weaved fabrics, twill weaved fabrics, satin weaved fabrics, sateens weaved fabrics, velvet weaved fabrics, velveteens weaved fabrics.

15. Multi layered covering material according to claim 1, wherein material for said said inner layer (2) is selected from at least one of the following materials: glass fiber, rock fiber, glass wool, rock wool, polyethylene, PVDC, polyester, naylon, rayon, thread of metal, preferably steel.

16. Multi layered covering material according to claim 2, wherein material for said said inner layer (2) is selected from at least one of the following materials: glass fiber, rock fiber, glass wool, rock wool, polyethylene, PVDC, polyester, naylon, rayon, thread of metal, preferably steel.

17. Multi layered covering material according to claim 3, wherein material for said said inner layer (2) is selected from at least one of the following materials: glass fiber, rock fiber, glass wool, rock wool, polyethylene, PVDC, polyester, naylon, rayon, thread of metal, preferably steel.

18. Multi layered covering material according to claim 1, wherein said covering material further comprises padding (4), preferably of highly water-permeable, non-retentive, non-moisture storing foam.

19. A Process for making multi covering material for elements making furniture more comfortable comprising upholstery, cushions, blankets, and similar elements, said multi layered covering material comprising steps of aligning outer layer (1) comprised of at least one user friendly material prone to change shape under environmental influence, preferably moisture over inner layer (2) comprised of material essentially resistant to shape change under environmental influence, and connecting said layers together, preferably by gluing or stitching, said connecting performed in connecting point wherein said connecting point comprises only part of surfaces of said inner (2), and said outer (1) layers.

20. The process according to claim 19 wherein said connecting is stitching.
